(19) United States
(12) Patent Application Publication
(10) Pub. No.: US 2002/0165813 A1
(43) Pub. Date: Nov. 7, 2002

(54) System, method and visual interface for searching for objects having multiple attributes

(76) Inventor: Juhnyoung Lee, Yorktown Heights, NY (US)

Correspondence Address: McGuire Woods, LLP, 1750 Tysons Boulevard, Suite 1800, McLean, VA, 22102-3915, US

(21) Appl. No.: 09/848,427

(22) Filed: May 4, 2001

(51) Int. Cl. G06F 17/60

(52) U.S. Cl. 705/37; 705/26

(57) ABSTRACT

A system, method and visual interface for searching for objects having multiple attributes. The system, method and visual interface includes one or more target areas for bid lines represented in a Cartesian coordinate system. The system, method and visual interface also includes a target line which is representative of a desired or optimal attribute value. The system, method and visual interface calculates a distance between the target line and the sell bids to determine the closest bid line and hence a desirable sell bid.

### CROSS REFERENCE TO RELATED APPLICATIONS

The invention described in this application is related in subject matter to the disclosure in copending patent application Ser. No. 09/723,236 filed Nov. 28, 2000, by Ho Soo Lee and Juhyoung Lee for “Method and Visual Interface For Evaluating Multi-Attribute Bids In A Network Environment” (IBM Docket YOR9-2000-0713US1) and assigned to a common assignee herewith. The disclosure of application Ser. No. 09/723,236 is incorporated herein by reference.

### DESCRIPTION

### BACKGROUND OF THE INVENTION

1. Field of the Invention

The present invention generally relates to a method and system of searching and finding one or more objects that have desirable features from a set of objects that have two or more attributes and, more particularly, to online trading over a networked system where buyers and sellers make one or more trade deals on one or more products or services that have two or more attributes by using a Request For Quote (RFQ) process on an electronic marketplace. The present invention further relates to a visual interface that a user can utilize to examine and evaluate objects that have two or more attributes.

2. Background Description

Commerce over networks, particularly electronic commerce (e-commerce) over the Internet, has increased significantly over the past few years. Part of e-commerce enables buyers and sellers to make trades in one or more Web sites. Those Web sites are often referred to as electronic marketplaces, and provide one or more different forms of trading mechanisms including auction, reverse auction, and exchange. In an auction, one seller receives bids from one or more buyers for one or more products or services before making a transaction. In a reverse auction, one buyer receives bids from one or more potential sellers. In an exchange, multiple buyers and multiple sellers submit asks and bids, respectively, to a marketplace which makes matches between the asks and bids, either continuously or periodically.

Request for Quotes (RFQ) is a type of reverse auction where a request is submitted by a buyer to an electronic marketplace to invite potential sellers to bid on specific products or services needed by the buyer's company or public agency. RFQ process is useful in all markets that depend upon multiple attributes (i.e., more than just price). RFQ process allows buyers to manually select one or more bids from sellers after examining and comparing submitted sell bids. RFQ process also allows sellers to produce exactly what buyers require, leading to a strong rate of return due to high satisfaction ratings.

There exist certain computer tools that help buyers who use an RFQ process evaluate and select one or more winning bids among all the submitted bids. One example is the scoring function of Perfect.com's™ RFQ engine. This tool allows a buyer, when submitting an RFQ, to specify the subjective importance of relevant factors of products or services such as quantity, material quality, product quality ratings, merchant reputation, warranty, support, delivery time, delivery cost as well as price. Then, after receiving bids from sellers, the RFQ engine filters the sell bids by using the buyer's criteria, calculates the scores of individual bids by using the buyer's profile and a scoring function, and ranks the bids by score. The buyer, when presented with the filtered sell bids with their ranks, will then select the best bids (wining bids). The use of bid ranking by score of individual sell bids helps buyers to select winners without having to review lengthy unstructured text document describing product attributes and other factors relevant to the purchase.

Problems with the Prior Art

One problem with the prior art is that representing multiple attribute values of products or services with a single number may hide important information useful for bid selection from buyers. For example, it is usually impossible to distinguish non-dominated bids from dominated bids by just looking at score values of sell bids. A bid, Bid A, is dominated by another bid, Bid B, if the value of each attribute of Bid A is not better than that of each corresponding attribute of Bid B. In general, dominated bids need not be considered in the bid selection process by buyers because dominated bids (e.g., Bid A) are fully represented by their dominating bids (e.g., Bid B).

Another problem with the prior art system is that it is arbitrary and often extremely difficult for buyers to correctly and effectively assign importance value or “weight” to different attributes of a product or service. This fact is especially true when the buyer is not given any information about the algorithm of the scoring function, i.e., how the scoring function uses the weights of different attributes to generate a single score for different bids. It is possible, in many cases, that a score is assigned arbitrarily or in an unintended way.

Yet another problem with the weight assignment is that it is impossible to express relationships among different attributes. For example, a buyer may have a tradeoff relationship between price and delivery time of a product; that is, the user is willing to pay $100 more for a product/service if it can be delivered in a day, but still wants to review sell bids that take more than one day to deliver the product/service. It is not sufficient to express this kind of relationship among two attributes with an assignment of single weight value to each attribute.

Also, prior art systems, such as the scoring function of Perfect.com's™ RFQ engine, simplifies the bid selection process for buyers in some cases. However, as a result of the problems described above, buyers may misjudge submitted bids or need to examine lengthy unstructured text description on product/service attributes to understand and confirm the bid ranking given by such systems.

### SUMMARY OF THE INVENTION

An object of the present invention is to provide an improved system for market makers of electronic marketplaces to provide a visual interface for buyers of Request for Quotes (RFQ) processes over a network.

An object of the present invention is to provide an improved system for evaluating submitted sell bids having two or more attributes.

An object of the present invention is to provide a system which does not require any assignment of weights to individual product/service attributes when evaluating submitted sell bids having two or more attributes.

An object of the present invention is to provide a system that shows all the attributes values in a single screen without any omission.

An object of the present invention is to provide a system with a set of filters in the interface which can be dynamically customized by business rules provided by buyers.

An object of the present invention is to provide a system which allows a buyer to dynamically select one or more desirable attribute values.

An object of the present invention is to provide a system which allows a buyer to dynamically select one or more desirable attribute values and provide a set of bids that most closely satisfy the selected desirable attribute values.

The present invention provides an improved system, method and visual interface for searching and finding objects having one or more attributes by providing the visual interface displaying sell bids along with an editable view of an RFQ. The interface also provides a target area showing desirable attribute values with the view of submitted sell bids. Also, the present invention allows a user to specify desirable attributes directly in the view of sell bids, and provide a set of sell bids that most closely satisfy the desirable attribute values specified in the bid view.

In order to accomplish the objectives of the present invention, a computer system which assists in the search for one or more sell bids among two or more sell bids is provided. The system includes an initial view generator that creates an initial view of at least one sell bid on a visual interface. The initial view being represented by bid lines in a Cartesian coordinate system. The system further includes one or more target lines created by one or more target line modules in the target areas. One or more winning bid list generator modules creates one or more winning bid lists based on the one or more target lines in the one or more target areas.

In another aspect of the present invention a method is provided for assisting the search for one or more sell bids among two or more sell bids. A machine readable medium containing code may also implement the steps of the method of the present invention. The steps include receiving a Request for Quotes (RFQ) and one or more sell bids that are submitted to the RFQ, and creating one or more RFQ views on a visual interface. The method further includes the steps of creating one or more bid views in a Cartesian coordinate system and one or more bid scores on a visual interface. A filtering operation, target area operation, and/or target line operation may also be executed in accordance with the present invention. A winning bid is then chosen.

An interface for assisting the search for one or more sell bids among two or more sell bids is further provided by the present invention. The interface includes a Request for Quotes (RFQ) view that displays RFQ under consideration, and a bid view that displays a set of sell bids submitted to the RFQ under consideration. The interface further includes one or more attribute lines and one or more bid lines. The bid lines are represented in a Cartesian coordinate system. One or more attribute check-boxes and filters may also be provided in embodiments. The interface further includes one or more target areas and one or more target lines. The target lines represent one or more desirable attribute values specified in the bid view.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of system architecture of an electronic marketplace in accordance with the present invention;

FIG. 2 is an example of a Request for Quotes (RFQ) having multiple attributes;

FIG. 3 is an example of bids having multiple attributes;

FIG. 4 is a visual interface displaying bids in accordance with the present invention;

FIG. 5 is a flow chart of a RFQ process using a visual interface in accordance with the present invention;

FIG. 6 is a visual interface showing an editable RFQ view and a target area in a bid view in accordance with the present invention;

FIG. 7 is a visual interface showing a target line in accordance with the present invention; and

FIG. 8 is a system architecture for selecting winning bids in accordance with the present invention.

### DETAILED DESCRIPTION OF A PREFERRED EMBODIMENT OF THE INVENTION

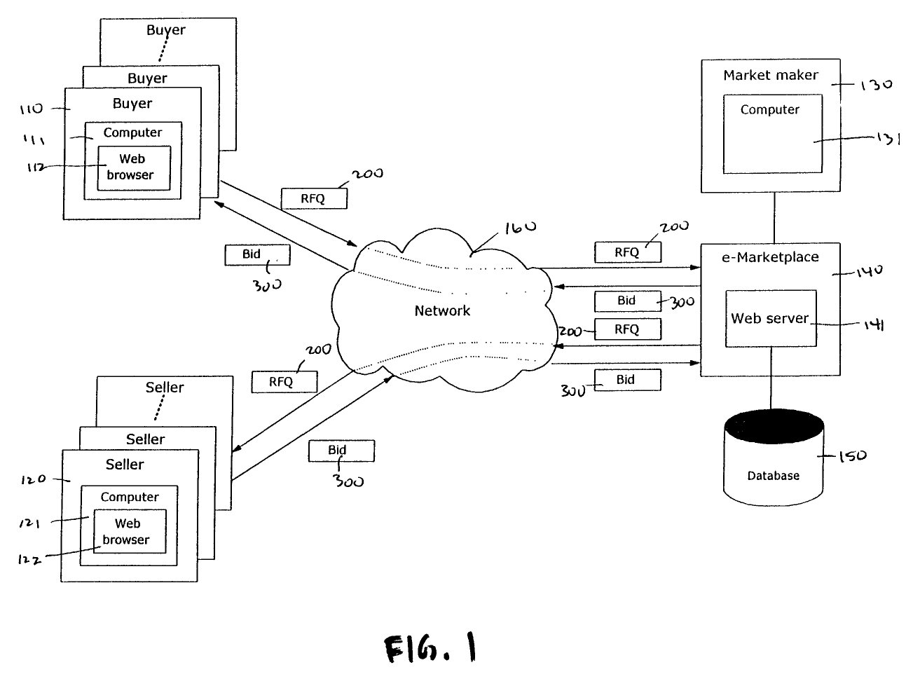

Referring now to the drawings, FIG. 1 shows a block diagram of a system architecture of an electronic marketplace in accordance with the present invention. In particular, the architecture of the e-marketplace includes one or more buyers 110 accessing Web browser programs 112 via one or more computers 111. The buyers 110 submit Request for Quotes (RFQ) 200 via the web browser programs 112 over a network 160 to an e-marketplace 140 preferably implemented by a web server 141. The web server 141 stores the RFQ 200 as well as other information such as, for example, product catalogs, seller and buyer information and the like in one or more database system 150. A market maker 130 may operate the e-marketplace 140 via a computer 131. Once the RFQ 200 is submitted, the e-marketplace 140 will post the RFQ 200 on the web server 141.

Still referring to FIG. 1, one or more sellers 120 may access the e-marketplace 140 over the network 160 via a web browser program 122 residing on a seller computer 121. The web browser programs 112 and 122 as well as the web server 141 preferably use HyperText Transfer Protocol (HTTP). The sellers 120 may find and access the posted RFQ 200 via the web browser program 122, and thereafter submit one or more sell bids 300 having attribute values to the e-marketplace 140 via the network 160. The sell bid 300 and associated attribute values may be stored in the database 150 as well as transmitted to the buyer's web browser 112 over the network 160. Also, the web pages associated with both of the web browser programs 112 and 122 may provide a structured form for entering the appropriate information such as, for example, the RFQ and the submitted bids. The buyer 110 who made the RFQ 200 selects winners among the submitted sell bids 300.

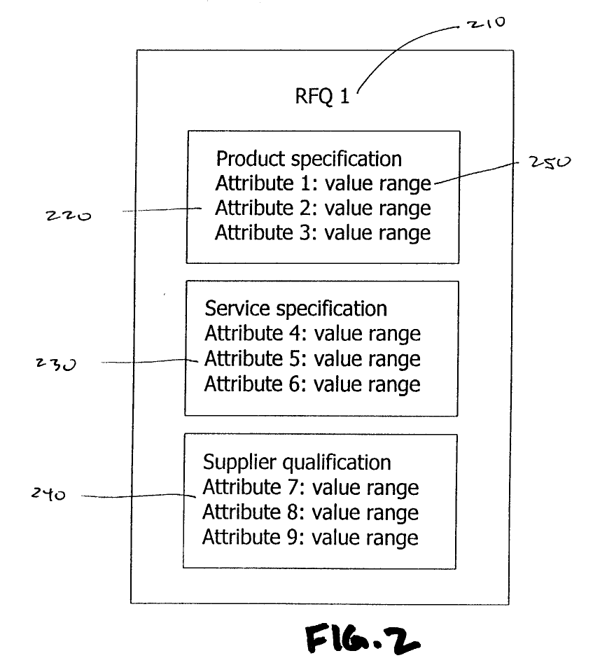

FIG. 2 is an example of an RFQ submitted by a buyer. An RFQ has an identification number 210 and comprises one or more attributes that may belong to one or more categories. Attributes are either numeric or categorical. Each attribute includes a pair of name and value range 250. The value range of a numeric attribute specifies the lower and upper limits of desirable attribute values. On the other hand, the value range of a categorical attribute specifies the names that are acceptable for the category. In the example of FIG. 2, there are three attribute categories: product specification 220 (which includes attributes such as price, material quality and properties, color and size), service specification 230 (which includes delivery time and cost, and warranty) and supplier qualification 240 (which includes trading history, experience and reputation). Each category has three attributes.

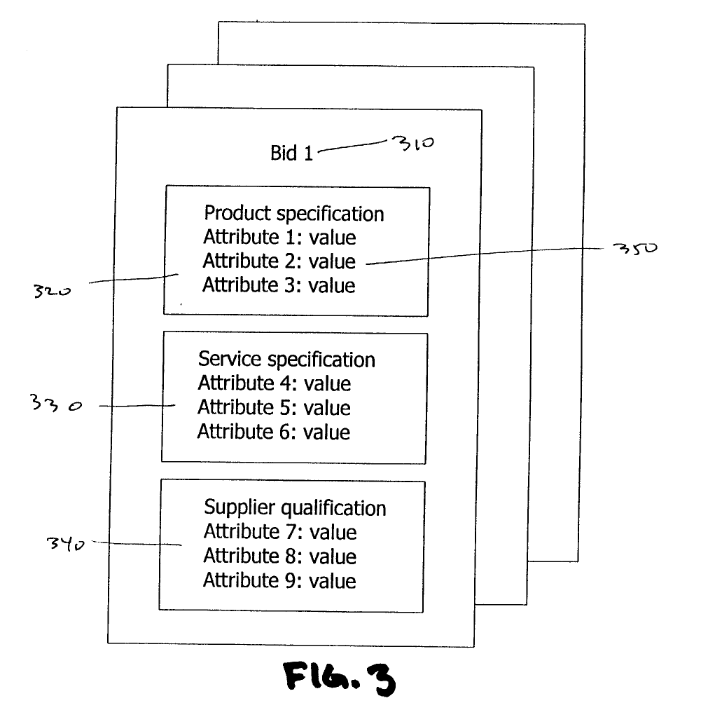

FIG. 3 is an example of bids submitted by sellers 120. A sell bid has an identification number 310 and comprises one or more attributes (and their values) that are specified in the RFQ 200 which this particular bid is submitted thereto. As in RFQ 200, attributes can be divided into several categories. Also, each attribute includes a name and value pair 350. In the example of FIG. 3, there are three attribute categories, i.e., product specification 320, service specification 330 and supplier qualification 340, each of which has three attributes.

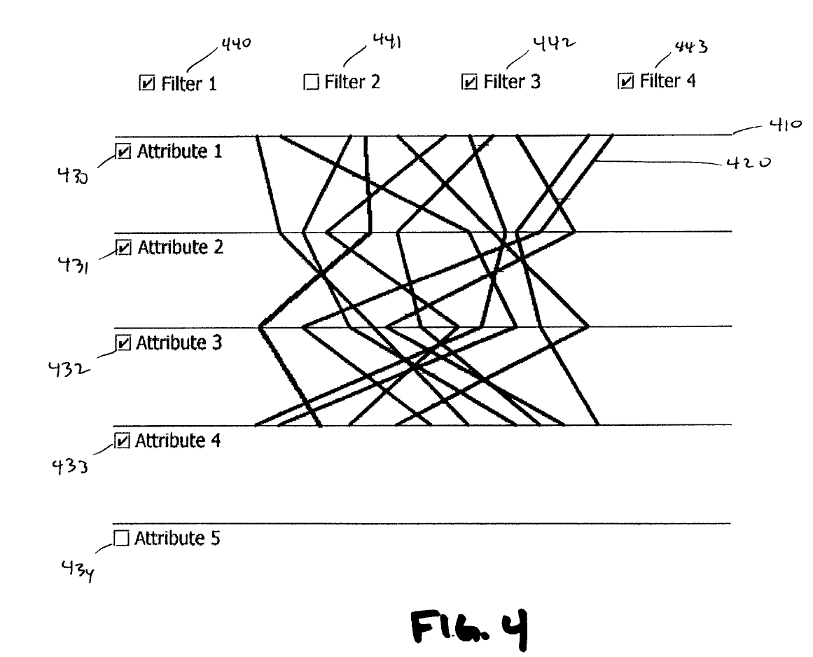

FIG. 4 is a visual interface displaying bids in accordance with the present invention. In this visual interface, an attribute is represented by a line 410. Two or more attributes are represented by lines that are parallel to each other (430, 431, 432, 433, and 434). Each parallel line is associated with a value coordinate (in a Cartesian coordinate system) that can specify values of the corresponding attribute. A sell bid has a value on each attribute line, and is represented by a collection of segmented lines 420 that connect the values of this bid on attribute lines 410. Each attribute, in the interface, is associated with a check-box 430, 431, 432, 433 and 434. While attributes with a check in the box (430, 431, 432, and 433) are included in the display of sell bids, attributes without a check in the box (434) are moved to the bottom of the interface and not included in the sell bid display. Also, the visual interface 400 has a set of filters 440, 441, 442 and 443 that can be used to filter in/out sell bids. A user can enforce a filter by using a check-box associated with the respective filter. In the example of FIG. 4, three filters (440, 442, and 443) are used to filter sell bids, while one filter (442) is not used for filtering.

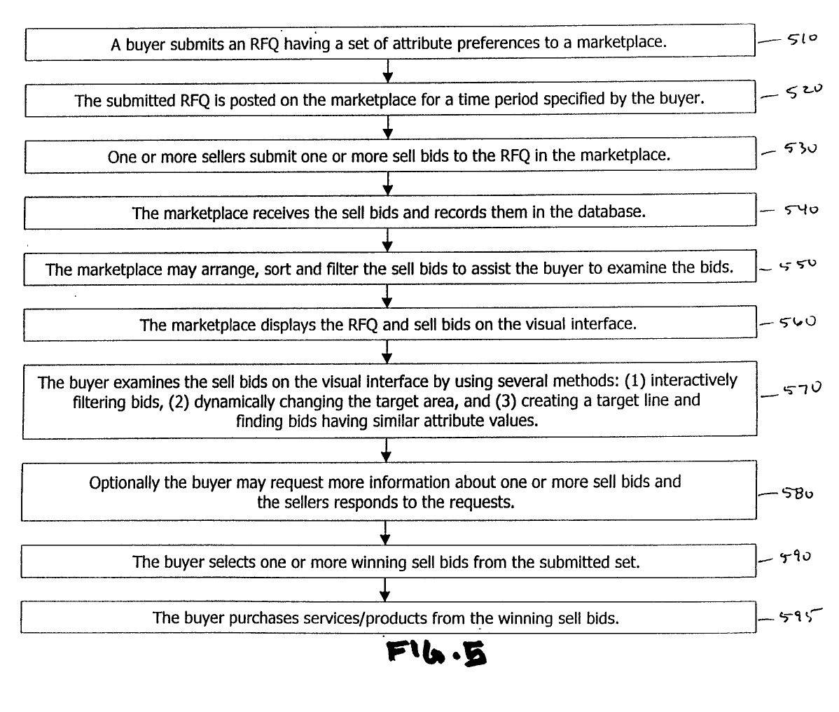

FIG. 5 is a flow chart of a RFQ process using a visual interface in accordance with the present invention. FIG. 5 can equally represent a high level block diagram capable of implementing the steps provided therein. At step 510, a buyer 110 submits an RFQ 200 for one or more products or services with a set of attribute preference to an e-marketplace 140. The attribute preference includes product attributes and other relevant factors including price, quantity, material quality, product quality ratings, merchant reputation, warranty, support, delivery time, and delivery cost. The attribute preference submitted by the buyer 110 will be used later for evaluating received sell bids by the market maker 130. Also, the buyer 110 is allowed to specify a criterion for the termination of the RFQ, typically in a form of time and date for termination. To help buyers specify all this information about an RFQ and also to automate the matching process of an RFQ and submitted sell bids, the market maker 130 of the e-marketplace 140 may provide a structured form (as one or more Web pages) for all the data entries described above. Also, the market maker 130 stores the submitted information about the RFQ 200 in the database system 150 of the e-marketplace 140.

At step 510, the buyer 110 of the RFQ 200 can also provide one or more business rules as part of the attribute preference set which describes the buyer's preference for various relevant factors including price, quantity, volume discount policy, material quality, product quality ratings, merchant reputation, warranty, support, delivery time, and delivery cost. Business rules specify one or more constraints on one or more attributes of the product or service. Also, business rules express various relationships among attributes of products or services. For example, the buyer 110 can have a business rule describing that the buyer is willing to pay $100 more if a seller can deliver the product of interest overnight while other conditions remain the same. This particular business rule specifies a relationship between price and delivery time. Business rules specified by the buyer 110 will be used at step 560 by the market maker 130 to create a visual interface 600 augmented by customized filters of business rules for the buyer 110.

At step 520, the submitted RFQ 200 is posted on the e-marketplace 140 for a time period specified by the buyer 110 inviting bids 300 from sellers 120 of the particular products or services specified in the RFQ 200. The attribute preference of the RFQ 200 may or may not be revealed to potential sellers in the e-marketplace depending on market type. In some cases, some of the attribute preference are posted while others are not posted. Next at step 530, one or more sellers 120 respond to the RFQ 200 by submitting bids 300 to the e-marketplace 140. The sellers 120 also specify various relevant factors in their bids including price, quantity, volume discount policy, material quality, product quality ratings, merchant reputation, warranty, support, delivery time and delivery cost. Again, to help sellers specify properties of their bids and also to automate the matching process of an RFQ 200 and submitted bids 300, the market maker 130 of the e-marketplace 140 may provide a structured form (as one or more Web pages) for all the data entries. Also, the market maker 130 stores the information about the submitted sell bids 300 in the database system 150 of the e-marketplace 140 at step 540.

When the RFQ 200 is terminated by the criterion specified by the buyer 10, the market maker 130 of the e-marketplace 140 retrieves the RFQ 200 and sell bids 300 from the database system 150 and examines them, either manually or by using one or more computer tools. The market maker 130 allows the buyer 110 to examine this raw data and to select winners among the submitted sell bids. Optionally, at step 550, the market maker 130 may process submitted sell bids 300 before presenting them to the buyer 110. For example, the market maker 130 may filter out bids that do not meet any one or more of the attribute preference specified by the buyer 110. Also, the market maker 130 may rank and sort the sell bids by score that is calculated by using one or more scoring algorithms.

Next, at step 560, the market maker 130 of the e-marketplace 140 creates a visual interface 600 customized for individual RFQs showing all the attributes of the RFQ 200 and their values of individual sell bids 300 in a single screen by using a parallel coordinate system. Business rules specified by the buyer 110, at step 510, are also augmented in the visual interface in a form of dynamic filters (440, 441, 442, and 443). In most cases, the buyer 110 returns to the e-marketplace 140 and finds the visual interface 400 of RFQ and sell bids posted in a specially determined place by the market maker 130 of the e-marketplace 140 Web site.

At step 570, the buyer 110 examines the sell bids 300 in the visual interface 600 and evaluates them to select one or more bids that meet the buyer's needs. In embodiments, there are several ways that a buyer can examine and evaluate sell bids in this visual interface 600. First, the buyer 110 can interactively select or de-select the attribute lines (430, 431, 432, 433, and 434) and/or the filters representing one or more business rules (440, 441, 442, and 443) to change the display of the given parallel coordinate-based visual interface 600 in an effort to compare sell bids 300 having different attribute values. In addition, the buyer 110 can examine if/how much a sell bid 300 is covered by the target area 630 which represents the desirable attribute value range in an RFQ 200. The buyer can also dynamically change the target area by using the editability of RFQ values in the RFQ view 610. Furthermore, the buyer can create a target line 640 directly in the visual interface 600, and permit the system report on one or more sell bids 300 that most closely satisfy the attribute values specified by the target line 640.

During the bid evaluation, optionally at step 580, the buyer 110 can request more information about one or more of the sell bids 300 in the interface 600. To help this information request process, the market maker 130 may provide one or more hyperlinks for each bid to Web pages that provide more information about the sell bid. By this, the buyer 110 only needs to click on the hyperlinks to read more information about the sell bid. In addition, the buyer 110 may request more information which is not readily available. For these cases, the market maker 130 may provide contact information including phone number, fax number, and/or email address of sellers in the sell bid interface 600. Furthermore, once the buyer 110 is connected to a seller 120 through a method suggested by the market maker 130, the buyer and seller can further negotiate about their bid in an effort to reach an agreement.

At step 590, after finishing the evaluation of sell bids 300, the buyer 110 selects one or more sell bids displayed in the visual interface 600 as winning bids 840. In some cases, it is possible that the buyer 110 does not select any bid as a winner. In this case, the buyer may submit a new RFQ with a modified set of attribute preferences and modified market rules. However, the present invention considers such a case a separate RFQ.

Finally, at step 595, the buyer 110 purchases products or services from the selected sell bids. Typically, the visual interface 600 given by the market maker 130 provides a buy button for each bid. To complete a transaction for a selected sell bid, the buyer 110 simply clicks on the buy button of the bid. This allows the buyer to provide necessary payment information for completing a transaction. In some cases, the buy button is connected with a shopping cart capability so that the buyer 110 needs to provide the payment information only once for payment of two or more selected bids. If the buy button capability is not available from the market maker 130, the buyer 110 may need to resolve the issues of payment and product shipping directly with the seller 120.

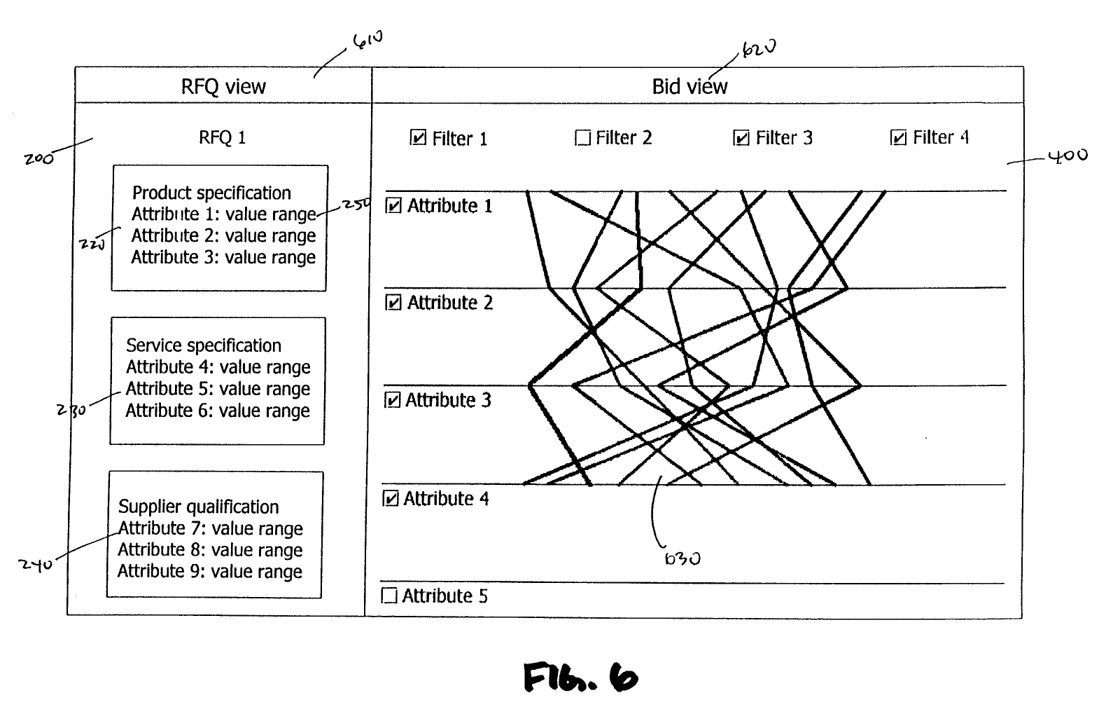

FIG. 6 is a visual interface showing an editable RFQ view and a target area in a bid view. The visual interface provides an RFQ view 610 that displays the details of the RFQ under consideration in addition to the bid view 620 that was given in the previous interface 400. Also, a target area 630 is shown in the bid view 620. A target area represents the range of attribute values desired by the buyer as specified in the given RFQ 200. That is, the target area 630 is determined by the value range of attributes specified by the buyer in the RFQ view 610. The target area 630 is displayed in a different colored or hued background in the bid view 620. The buyer can visually confirm which attribute value of a particular sell bid is covered by the target area 630 or not. When the buyer modifies (edits) the value range of one or more attributes in the RFQ view 610, the target area 630 in the bid view 620 is updated accordingly.

It is further submitted that the target area provides the user with a visual cue to intuitively understand if a sell bid has a set of desirable attribute values and how many sell bids satisfy the requirement of desirable attribute values. Furthermore, the value range of individual attributes 250 is editable, i.e., a buyer can dynamically change the desirable attribute values given in any attribute value range 250, and the target area displayed in the bid view 620 is accordingly modified to reflect the changes to attribute value range in real time. Again, the buyer can examine the sell bids 300 over the modified target area 630 to see if a sell bid has a set of desirable attribute values and the like.

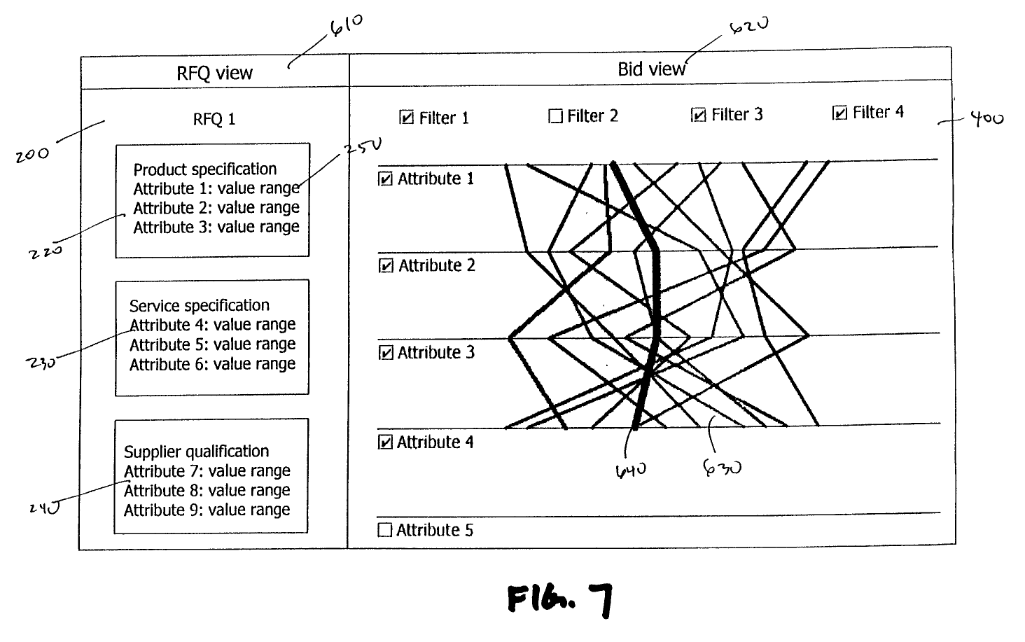

FIG. 7 is a visual interface showing a target line. A target line 640 is a collection of desirable values for individual attributes selected by a user directly on the bid view 620 portion of the visual interface by using one or more pointing device operations such as point and click on a graphical user interface. When a buyer specifies a set of desirable values for individual attributes in the form of a target line 640, the target line process 822 of the system calculates the distance which represents the proximity between the target line and every other bid line by using their attribute values. Then, the visual interface displays only the top N sell bid lines that are closest to the target line 640 among all the submitted bids 300, where N is a small number that is specified by the user.

The distance or proximity between the target line 640 and the sell bid line 420 can be computed by using a distance formula. An example of the distance formula is as follows:

Dᵢ=Σⱼwⱼ|aᵢⱼ−aₜⱼ|/Nⱼ, and

Nⱼ=maxᵢ(|aᵢⱼ−aₜⱼ|)

Dᵢ denotes the distance of a sell bid i from the target bid (target line). wⱼ represents the weight of the attribute j. aᵢⱼ and aₜⱼ denote the value of attribute j for bid i and the target bid, respectively. Nⱼ is the normalization factor for attribute j. In other words, the distance of a sell bid 300 from the target line 640 is the sum of the weighted distances of individual attributes divided by the normalization factor.

By using such a distance formula, a quantitative measure which reasonably represents how similar or distinctive a sell bid line 420 is to/from a target line 640 can now be provided. Note that the distance is decided by attribute values of sell bids. Also, if a target line does not specify values of all the attributes provided in the RFQ 200 because some of the attributes are excluded from the visual interface 600 by de-checking operation, only the attributes which are given the values are used in the computation of the distance of sell bids.

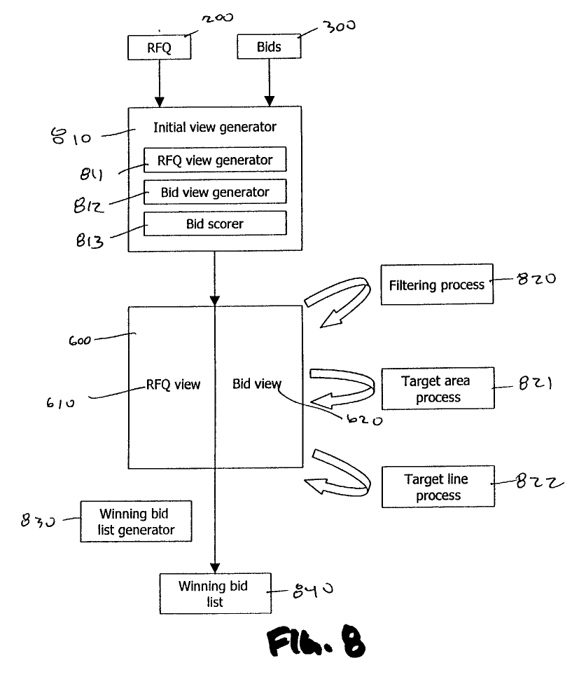

FIG. 8 is a system architecture for selecting winning bids. The initial view generator 810 of the system receives an RFQ 200 and one or more sell bids 300 submitted to the RFQ 200. The initial view generator 810 comprises three processes: (i) a RFQ view generator 811 which generates an editable RFQ view 610 by using the RFQ input 200 in the visual interface 600, (ii) a bid view generator 812 which creates a bid view 620 by using the bid input 300 in the visual interface 600 and (iii) a bid scorer 813 which calculates scores of sell bids by using the bids' attribute values and ranks them by score. The score of sell bids can be used in one or more filters that displays only top N sell bids, i.e., N sell bids that have highest scores, where N is a small number given by the user. In embodiments, the filter and sell bid scores can be part of the visual interface 600.

In embodiments, the RFQ view generator 811 can be implemented by using a computer programming language such as Java, JavaScript, and HTML that can render the digital data given by the RFQ input 200 to generate an editable RFQ view 610. The generated RFQ view 610 as part of the visual interface 600 can run out of the Web browser 112 on a buyer's computer 111. The bid view generator 812 can be implemented by using a computer programming language such as Java or Shockwave that support graphical rendering of digital data. The bid view generator 812 renders the digital data given by the bid input 300 to generate the bid view 620. The generated bid view 620 as part of the visual interface 600 can run out of the Web browser 112 on a buyer's computer 111. The bid scorer 813 calculates the score of sell bids by using the following equation:

Sᵢ=Σⱼwⱼf(aᵢⱼ), for all i

where Sᵢ denotes the score of a sell bid i, wⱼ the weight of the attribute j, aᵢⱼ the value of the attribute j of the sell bid i, and f( ) a transformation of the attribute value aᵢⱼ. The attribute values of sell bids, aᵢⱼ, are given in the bid input 300, while the attribute weights, wⱼ, are given in the RFQ input 200 along with the attribute value ranges. Once the bid scorer process calculates the scores of sell bids, it can rank them by score.

The visual interface 600 which is generated by the initial view generator 810 comprises two views: (i) a RFQ view 610 that displays a set of editable attribute name and value range pairs given by the RFQ under consideration and (ii) a bid view 620 that displays the given set of bids 300 submitted to the RFQ 200. The user can examine and evaluate the set of given sell bids 300 displayed in the visual interface 600 by using several mechanism including (i) a filtering process 820 that allows a buyer to interactively select or de-select the attribute lines (430, 431, 432, 433, and 434) and/or the filters representing one or more business rules (440, 441, 442, and 443) to change the display of the given sell bids, (ii) a target area process 821 that allows a buyer to examine if/how much a sell bid 300 is covered by the target area 630 and also dynamically change the target area by using the editability of RFQ values in the RFQ view 610 and (iii) a target line process 822 that allows a buyer to create a target line 640 directly in the visual interface 600, and permits the system report on one or more sell bids 300 that most closely satisfy the attribute values specified by the target line 640. (The term “process” may equally represent, throughout the description herein, a module or mechanism for performing the described specific process.) A user can create an imaginary target bid by specifying a set of desirable attribute values in the RFQ view 610, and the specified target bid is visualized in the bid view 620 as the target line 640. Once a target line 640 is created, the buyer can compare any sell bid shown in the bid view 620 for one or more of their attribute values. Also, the nearness or distance of a sell bid to the imaginary bid represented by the target line 640 can be quantitatively calculated by using the equation given in Claim 22. The winning bid list generator 830 allows a buyer 110 to create one or more winning bid lists 840 after bid evaluation in the visual interface 600 for record and/or completing transactions with the winning bids.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A computer system for assisting to search for one or more sell bids among two or more sell bids, comprising:
an initial view generator that creates an initial view of at least one sell bid on a visual interface, the at least one sell bid being represented by bid lines in a Cartesian coordinate system, the bid lines intersecting with at least one attribute preference line;
one or more target area modules that creates one or more target areas on the visual interface, the bid lines being located within the target area;
one or more target line modules that creates one or more target lines on the visual interface, the one or more target lines being representative of values for individual attributes; and
one or more winning bid list generator modules that creates one or more winning bid lists based on the one or more target lines in the one or more target areas.

2. The system of claim 1, further comprising one or more filtering modules that executes one or more filters on the visual interface in order to change the initial view of the at least one sell bid in accordance with one or more business rules. 16.

3. The system of claim 1, wherein the one or more target line modules allowing a visual comparison between the one or more sell bids which are closest to the one or more target lines in the one or more target areas.

4. The system of claim 1, further comprising one or more central processing units (CPUs), one or more memories and one or more network interface to one or more networks associated with the one or more visual interface.

5. The system of 1, wherein the at least one sell bid comprises one or more attributes.

6. The system of 5, wherein the one or more attributes is a pair of name and value, and is grouped into categories including product specification, service specification, and supplier qualification.

7. The system of 6, wherein the product specification includes attributes such as price, material quality and properties, color and size

8. The system of 6, wherein the service specification includes delivery time and cost, and warranty.

9. The system of 6, wherein the supplier qualification includes trading history, experience and reputation.

10. The system of 6, wherein the value range of a numeric attribute specifies lower and upper limits of desirable attribute values, and the value range of a categorical attribute specifies names that are acceptable for the category of the categories.

11. The system of 1, wherein the at least one the sell bid is submitted to one or more Request for Quote (RFQ).

12. The system of 11, wherein:
the RFQ comprises one or more attributes;
the one or more sell bids represents any object that has one or more attributes; and
the RFQ represents any object that has one or more attributes.

13. The system of 1, wherein the initial view generator module comprises one or more RFQ view generator modules, one or more bid view generator modules, and one or more bid scorer modules.

14. The system of 13, wherein the one or more RFQ view generator modules creates one or more RFQ views of input RFQ.

15. The system of 13, wherein the one or more bid view generator modules creates one or more bid views of input sell bids.

16. The system of 13, wherein the one or more bid scorer modules creates a score for each sell bid in the input set of the at least one sell bid, and ranks the at least one sell bid by score.

17. The system of 2, wherein the filtering module includes a show-top-N operation that displays the bid lines of the at least one sell bid that are ranked top N by the bid scorer module, where N is a number specified by the user.

18. The system of 1, wherein the one or more target area modules at least creates and modifies a region of desirable attribute value ranges in the bid view of the visual interface.

19. The system of 1, wherein the one or more target line modules creates a set of attribute values on the bid view of the visual interface by using one or more pointing device operations.

20. A method of assisting to search for one or more sell bids among two or more sell bids comprising the steps of:
receiving a Request for Quotes (RFQ) and one or more sell bids that are submitted to the RFQ;
creating one or more RFQ views on a visual interface;
creating one or more bid views on a visual interface in a Cartesian coordinate system, the bid views being represented by bid lines associated with the one or more sell bids;
creating one or more bid scores on a visual interface based on attribute values of the one or more sell bids;
executing at least one of (i) one or more filtering operations, (i) one or more target area operations, and (iii) one or more target line operations on the visual interface; and
executing one or more winning bid list generating operations to create one or more winning bid lists based on the executing step, wherein
the filtering operations execute one or more filters on the visual interface in order to change the bid view in accordance with one or more business rules,
the target area operations create one or more target areas on the visual interface such that the bid lines are located within the one or more target areas,
the target line operations create one or more target lines on the visual interface which allows a visual comparison between the bids lines which are closest to the one or more target lines in the one or more target areas.

21. The method of claim 20, further comprising the step of calculating a distance between the one or more target lines and a desired sell bid.

22. The method of claim 21, wherein the distance between the desired sell bid and the one or more target lines is calculated by
Dᵢ=Σⱼwⱼ|aᵢⱼ−aₜⱼ|/Nⱼ, and
Nⱼ=maxᵢ(|aᵢⱼ−aₜⱼ|)
wherein
Dᵢ denotes the distance of a sell bid i from the target line,
wⱼ represents a weight of attribute j.
aᵢⱼ and aₜⱼ denote a value of the attribute j for sell bid i and the target line, respectively.
Nⱼ is a normalization factor for the attribute j.

23. An interface for assisting to search for one or more sell bids among two or more sell bids comprising:
a Request for Quotes (RFQ) view that displays RFQ under consideration, and a bid view that displays in a Cartesian coordinate system a set of sell bids submitted to the RFQ under consideration;
one or more attribute lines that represent one or more attributes specified in the RFQ and the set of sell bids;
one or more bid lines that represent the one or more sell bids, the bid lines being represented in the Cartesian coordinate system;
one or more target areas that represent desirable attribute value ranges specified in the RFQ; and
one or more target lines that represent one or more desirable attribute values specified in the bid view.

24. The interface of claim 23, wherein the RFQ view provides one or more attribute name and value range pairs.

25. The interface of claim 24, wherein the value range of an attribute is editable.

26. The interface of claim 23, wherein the one or more target lines permit selection of attribute values for a subset of the attributes given in the RFQ under consideration.

27. The interface of claim 23, wherein selecting a target line of the one or more target lines results in a display of N sell bids that are closest to the target line in distance, where N is a number specified by the user.

28. The interface of claim 27, wherein the distance between the sell bids and the target line is computed by
Dᵢ=Σⱼwⱼ|aᵢⱼ−aₜⱼ|/Nⱼ, and
Nⱼ=maxᵢ(|aᵢⱼ−aₜⱼ|)
wherein
Dᵢ denotes the distance of a sell bid i from the target line,
wⱼ represents a weight of attribute j.
aᵢⱼ and aₜⱼ denote a value of the attribute j for sell bid i and the target line, respectively.
Nⱼ is a normalization factor for the attribute j.

29. The interface of claim 27, wherein the distance of the sell bid from the target line is a sum of the weighted distances of individual attributes divided by a normalization factor.

30. The interface of claim 23, further comprising:
one or more attribute check-boxes that allow a select or de-select the one or more attributes; and
one or more filters that allow to filter the bid lines displayed in the bid view.

31. A machine readable medium containing code for searching for one or more sell bids among two or more sell bids, the code implementing the steps of:
receiving a Request for Quotes (RFQ) and one or more sell bids that are submitted to the RFQ;
creating one or more RFQ views on a visual interface;
creating one or more bid views on a visual interface in a Cartesian coordinate system, the bid views being represented by bid lines associated with the one or more sell bids;
creating one or more bid scores on a visual interface based on attribute values of the one or more sell bids;
executing at least one of (i) one or more filtering operations, (i) one or more target area operations, and (iii) one or more target line operations on the visual interface; and
executing one or more winning bid list generating operations to create one or more winning bid lists based on the executing step, wherein
the filtering operations execute one or more filters on the visual interface in order to change the bid view in accordance with one or more business rules,
the target area operations create one or more target areas on the visual interface such that the bid lines are located within the one or more target areas,
the target line operations create one or more target lines on the visual interface which allows a visual comparison between the bids lines which are closest to the one or more target lines in the one or more target areas.
